(19) United States
(12) Patent Application Publication
(10) Pub. No.: US 2002/0176334 A1
(43) Pub. Date: Nov. 28, 2002

(54) Method and system for generating a tracking error signal

(75) Inventor: Yutaka Yamanaka, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/151,957

(22) Filed: May 22, 2002

(30) Foreign Application Priority Data
May 24, 2001 (JP) 2001-155250

(51) Int. Cl. G11B 7/095

(52) U.S. Cl. 369/44.29; 369/44.35; 369/44.37; 369/53.31

(57) ABSTRACT

A method for generating a tracking error signal includes the steps of detecting a first signal representing the amount of reflected light, judging presence or absence of a pit on the current track, and averaging the first signal with respect to time while inverting the detected signal obtained during the presence or absence of the pit. An effective tracking error signal can be obtained in the case of a track pitch smaller than a pitch resolution limit.

### BACKGROUND OF THE INVENTION

(a) Field of the Invention

The present invention relates to a method and a system for generating a tracking error signal and, more particularly, to a method and a system for generating a tracking error signal used in an optical disk drive for reading data on an optical disk or optical card.

(b) Description of the Related Art

A variety of optical disks, such as CD (compact disk) and DVD (digital versatile disk), are used for recording a variety of data. In such an optical disk, data are recorded by forming a small depression, called phase pit, on a substrate while modulating the location of the phase pit with desired information.

FIG. 1 is a partial top plan view of a typical optical disk, wherein an elongate pit 11 is arranged along a track 12 while being modulated with respect to the location thereof based on recording data. Typical track 12 formed on the disk has a spiral shape. Some tracks, however, may have a linear shape in the case of an optical card, for example. In any case, the tracks 12 are arranged with a specified space being interposed between each adjacent two of the tracks 12, thereby avoiding interference between the adjacent tracks 12 during reproduction of the recorded data. The space is generally called track pitch.

The pits or pit train formed on the track may use the change of reflectivity on the optical disk other than the phase change used by the phase pit as described above. The pit may have other forms such as a hole of a metallic film or may use a difference of the optical characteristics between the crystal and amorphous states of the disk surface, other than the ordinary pit or depression of the disk surface. It is to be noted that although the length of the pit or the space between the pits along the track is modulated in FIG. 1, the location of the pit edge may be modulated, with the period of the pits being maintained constant.

An optical disk drive scans the tracks having the pit train such as described above by using a small optical spot 14, and detects the optical spot 14 after reflection or passing thereof by the optical disk for reproduction of the recorded data. In order to accurately reproduce the recorded data, the optical spot should not deviate from the track center, which necessitates detection of a tracking error signal representing the deviation of the optical spot 14 with respect to the track center.

Methods for generating the tracking error signal include one using a push-pull scheme. The push-pull scheme will be described hereinafter with reference to drawings. FIGS. 2A to 2C show the locational relationships between the center of the pit 11 and the optical spot 14, whereas FIGS. 3A to 3C show far-field distributions of the reflected light, wherein the distributions of the amount of reflected light are shown corresponding to the relative locations of FIGS. 2A to 2C, respectively.

The reflected light in general has a far-filed distribution, which follows the relative locations of the optical spot 14 with respect to the pit 11 having a reflectivity or optical phase different from the reflectivity or optical phase of the other area. The push-pull scheme takes advantages of the characteristic of the far-field distribution, wherein the far-field distribution corresponds to the deviation of the optical spot 14 with respect to the pit center. In FIGS. 3A to 3C, distance with respect to the track center is plotted on abscissa, whereas the amount of the reflected light at the location is plotted on the ordinate.

As understood from FIGS. 3A to 3C, the far-field distribution of the reflected light has a symmetry with respect to the ordinate if the optical spot 14 is aligned with the pit 11 (FIGS. 2B and 3B), whereas the far-field distribution has an asymmetry with respect to the ordinate if the optical spot 14 is deviated from the pit 11 (FIGS. 2A and 3A, FIGS. 2C and 3C). In addition, the direction of the deviation in the asymmetric far-field distribution depends on the direction of the deviation of the optical spot 14 with respect to the pit 11.

FIG. 4A shows a photodetector having an equally divided pair of light receiving surfaces 15, wherein a reflected light 16 is shown at the center of the photodetector by a dotted line. By receiving the reflected light 16 by the divided receiving surfaces 15 and obtaining the difference between the optical amounts received by the divided receiving surfaces 15 to generate a push-pull signal, the push-pull signal has an amplitude in a substantially linear relationship with respect to the deviation of the optical spot 14 from the track center, as shown in FIG. 4B. The push-pull signal is used as a tracking error signal after some processing. There is a variation for detection of the reflected light, such as shown in FIG. 4C, wherein the divided receiving surfaces 15 of the photodetector in combination thereof are smaller than the reflected light spot 17. This allows the receiving surfaces 15 to detect the reflected lights having a higher change rate of the optical amount in the far-field distribution.

The difference signal as provided by the push-pull scheme is obtained only from the pits and is not obtained theoretically from the mirror surface between the adjacent pits. However, since the band of the tracking error signal used for servo control of the optical spot is significantly lower than the repetitive frequency of the pits, a desired tracking error signal can be obtained from the push-pull signal by calculating the time average of the sampled push-pull signals as by passing the sampled push-pull signals through a low-pass-filter.

For increasing the recording density of the optical disk, the track pitch 13 should be reduced. However, a smaller track pitch 13 increases the influence by the configuration of the adjacent tracks upon the light distribution from the central track or current track, whereby signal sensitivity for the tracking error signal is degraded. The track pitch dependency of the signal sensitivity for detecting the tracking error signal was measured to reveal reduction of the sensitivity of the tracking error signal, as shown in FIG. 5, wherein the detection sensitivity for the tracking error signal is plotted against the track pitch. As understood from the figure, the detection sensitivity assumes substantially zero around the track pitch known as a pitch resolution limit λ/(2×NA), which is defined by the numerical aperture (NA) of the lens for the optical spot and the wavelength λ of the optical source.

In sort, the conventional method has a problem in that a smaller track pitch prevents stable generation of the tracking error signal.

### SUMMARY OF THE INVENTION

In view of the above, it is an object of the present invention to provide a method and a system for generating a tracking error signal, which is capable of detecting a stable tracking error signal even in the case of a smaller track pitch.

The present invention provides a method for generating a tracking error signal including the steps of: irradiating an optical spot onto a current track of an optical disk; generating a first signal representing an amount of reflected light from the optical disk; judging presence or absence of a pit irradiated by the optical spot on the current track; and averaging the first signal with respect to time while inverting the first signal obtained during either the presence or the absence of the pit.

The present invention also provides a tracking error signal generating system comprising: an optical unit for irradiating an optical spot onto a current track of an optical disk; a photosensor unit for generating a first signal representing an amount of reflected light from the optical disk; a judgement section for judging presence or absence of a pit irradiated by the optical spot on the current track; and a signal processing section for averaging the first signal with respect to time while inverting the first signal obtained during either the presence or the absence of the pit to generate a tracking error signal.

In accordance with the method and system of the present invention, by judging presence or absence of a pit irradiated by the optical spot on the current track and averaging the first signal with respect to time while inverting the first signal detected during either the presence or the absence of the pit, an effective tracking signal can be obtained having an odd function property even in the case of an optical disk having a small track pitch as low as below a pitch resolution limit.

The above and other objects, features and advantages of the present invention will be more apparent from the following description, referring to the accompanying drawings.

### BRIEF DESCRIPTION OF THE DRAWINGS

FIG. 1 is a partial top plan view of an optical disk.

FIGS. 2A to 2C are details of FIG. 1, showing relative location of the optical spot and the pitch.

FIGS. 3A to 3C are graphs showing far-field distributions of the reflected light, corresponding to FIGS. 2A to 2C, respectively.

FIG. 4A shows a detail of the light receiving surface of a photodetector, FIG. 4B is a push-pull signal obtained from the photodetector of FIG. 4A, and FIG. 4C shows another example of the photodetector.

FIG. 5 is a graph showing the detection sensitivity for the tracking error signal.

FIG. 6A is a partial top plan view of an optical disk used in a method according to a first embodiment of the present invention, showing possible different arrangements of pits on the tracks in the case of a “narrow pitch arrangement”.

FIG. 6B show graphs of detected signals corresponding to the arrangements shown in FIG. 6A.

FIGS. 7A and 7B show a partial top plan view and graphs in the case of a “cut-off arrangement”, similarly to FIGS. 6A and 6B, respectively.

FIG. 8 is a graph showing the relationship between the detection sensitivity and the track pitch.

FIG. 9 is a graph showing the relationship between the crosstalk and the track pitch.

FIG. 10A shows the locational relationship between an optical spot and the track center, and FIG. 10B shows the far-field distribution for the arrangement of FIG. 10A.

FIG. 11A shows the locational relationship between a pair of optical spots and the track center, and FIG. 11B shows the far-field distribution for the arrangement of FIG. 11A.

FIG. 12 is a block diagram of a drive circuit using the method of the second embodiment.

FIG. 13 shows eye patterns of typical reflected light, and process for separating the reflected light into a plurality of levels.

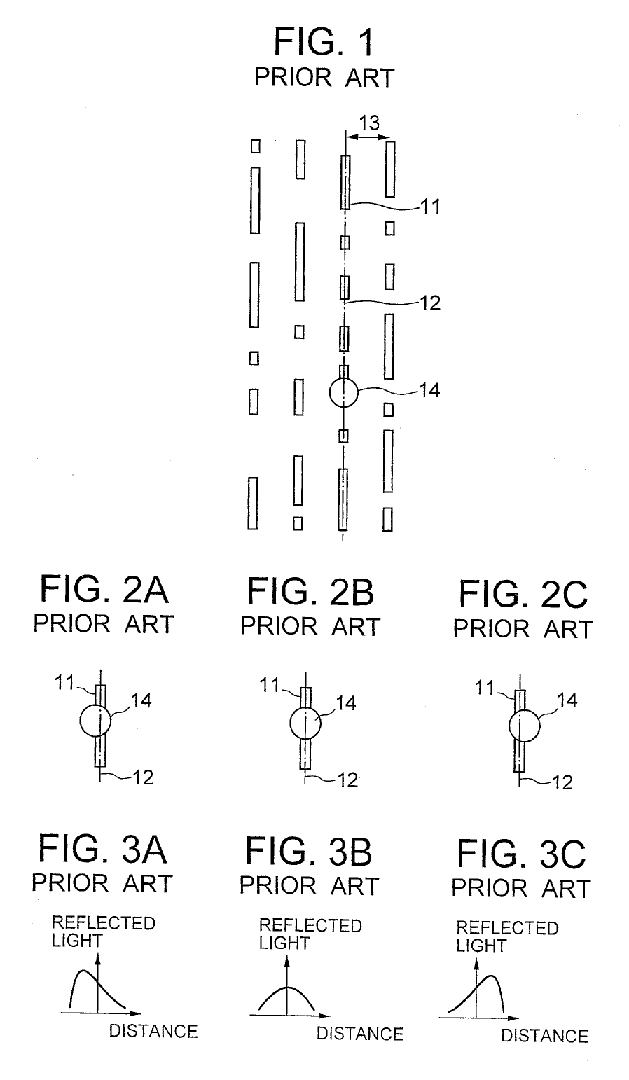

### PREFERRED EMBODIMENTS OF THE INVENTION

Now, the present invention is more specifically described based on preferred embodiments thereof with reference to accompanying drawings, wherein similar constituent elements are designated by similar reference numerals throughout the drawings.

[First Embodiment]

The first embodiment is such that the present invention is applied to a push-pull scheme.

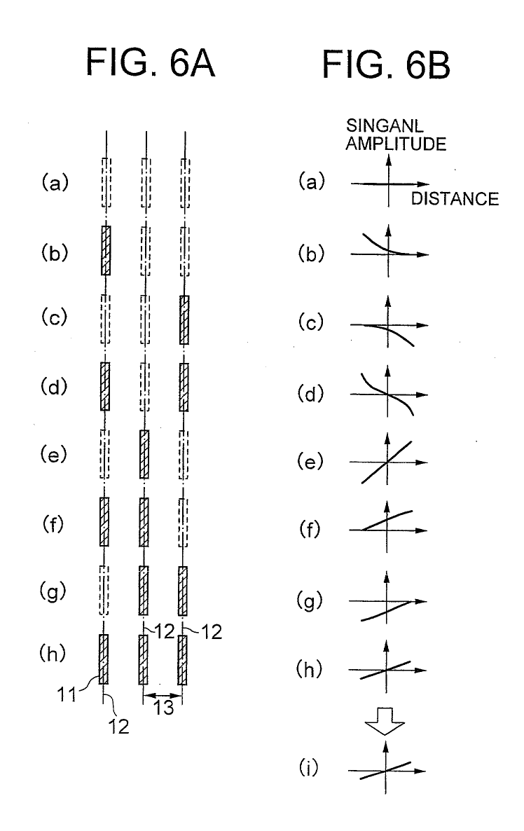

FIG. 6A shows schematic arrangements of pits along tracks in an optical disk, wherein the presence of the pit 11 is shown by shading and the absence of the pit 11 is depicted by a dotted line. In FIG. 6A, the central track 12 is the current track onto which the optical spot irradiates, and both the side tracks 12 are disposed adjacent to the central track 12, with a track pitch being shown by numeral 13. Sections (a) to (h) in FIG. 6A show possible different arrangements of the pits 11, corresponding to the eight cases where the central track 12 has or has not a pit 11, the left track 12 has or has not a pit 11 and the right track 12 has or has not a pit 11 in the vicinity of the optical spot.

FIG. 6B shows the relationships between the tracking error signals and the deviations of the optical spot with respect to the central track in sections (a) to (h) of FIG. 6B corresponding to the cases shown in sections (a) to (h), respectively, of FIG. 6A.

In general, since the signal modulation is performed such that the total length of the presence of the pit and the total length of the absence of the pit are roughly equal to each other during a specified time interval. Thus, the probabilities of occurrences of the eight cases are roughly equal to one another. If the track pitch is smaller, then the detected tracking error signal is changed due to the affection by the adjacent tracks.

In the optical disk having a small track pitch shown in FIG. 6A, the tracking error signal detected for the central track 12 is affected by the presence or absence of the pit on the adjacent tracks, which is especially clearly shown in sections (b), (c), (d) of FIG. 6B wherein the detected tracking error signal should be zero.

The final tracking error signal is obtained by averaging the detected signal with respect to time, is calculated as the sum of the signals shown in sections (a) to (h), and shown in section (i) of FIG. 6B. This may be understood from the fact that signals in sections (b) and (g) cancel each other, signals in sections (c) and (f) cancel each other, and the signals in the remaining sections are odd functions. The arrangement of tracks in FIG. 6A is referred to as “narrow track arrangement” herein.

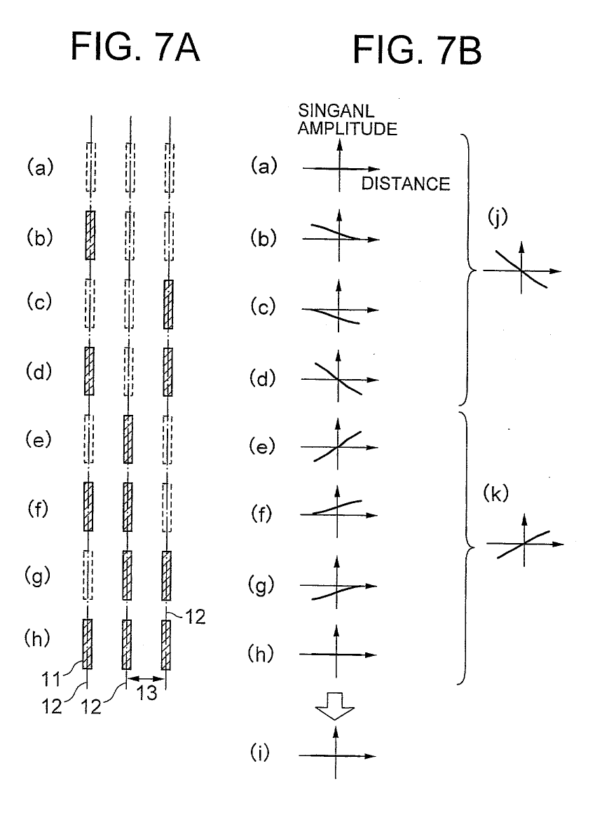

FIGS. 7A and 7B show another optical disk having a smaller track pitch, similarly to FIGS. 6A and 6B, respectively. In FIG. 7A, the track pitch is smaller than the pitch resolution limit, λ/(2×NA), of the optical spot. In this case, the sum of the sampled tracking error signals in sections (a) to (h) amounts to zero as shown in section (i) of FIG. 7B. This will be understood from the fact that the signal in section (h) of FIG. 7B assumes zero due to the track pitch falling below the pitch resolution limit of the optical spot. FIG. 5 shows the relationship between the detection sensitivity and the track pitch, revealing the pitch resolution limit. The arrangement of tracks in FIG. 7A is called “cut-off arrangement” herein.

In either case of the narrow track arrangement shown in FIG. 6A and the cut-off arrangement shown in FIG. 7A, the tracking error signal provides some sensitivity in most cases among the respective eight cases. It is to be noted that the detected tracking error signals shown in (b), (c) and (d), in each of FIGS. 6B and 7B, have the same polarity for servo control, which are reverse to the polarity for the servo control shown in sections (e) to (h). The term “polarity for servo control” as used herein corresponds to the polarity of the differential of the far-field distribution with respect to the distance from the disk center. The term “polarity for servo control” may be abbreviated as “polarity” in this text.

Accordingly, if the tracking error signals having the same polarity are added together for averaging, a tracking error signal having an odd function property can be obtained, as shown in sections (j) and (k) in FIG. 7B, even in the case of the cut-off arrangement. It is to be noted that the polarity of the tracking error signal depends on the presence or absence of the pit in the central track, as will be understood from these drawings. Accordingly, it is possible to extract signals having the same polarity for addition by judging the presence or absence of the pit on the central track at the position of the optical spot.

More specifically, if the central track has no pit thereon at the optical spot, as in the cases of sections (a) to (d) in FIGS. 6B or 7B, the detected signal is inverted, whereas if the central track has a pit thereon at the optical spot, as in the cases of sections (e) to (h) in FIGS. 6B or 7B, the polarity of the detected signal is non-inverted, i.e., maintained as it is. The inverted signal and the non-inverted signal thus obtained are added together for averaging of the sampled signals with respect to time, thereby obtaining an effective tracking error signal having an effective amplitude and an odd function property.

In a practical method for generating the effective tracking error signal, the tracking error signal detected in the case of presence of the pit in the central track and in the case of absence of the pit in the central track is extracted by sampling independently of each other to form respective groups. First group of sampled signals in the case of the presence of the pit and second group of the sampled signals in the case of the absence of the pit are added together for synthesis, for example, after inversion of the sampled signals in the first group or second group. In any method for synthesis, the presence or absence of the pit determines the selection of inversion or non-inversion, or vice versa, of the sampled signals.

In the cut-off arrangement shown in FIG. 7A, since the amplitudes of the inverted sampled signals and the amplitudes of the non-inverted sampled signals are substantially equal, the synthesis of these signals are performed at an equal ratio, i.e., at a ratio of 1:1. However, in the narrow track arrangement, i.e., in the case of a larger track pitch, the ratio should be different because the detection sensitivity has a difference between the case of the presence of the pit and the case of the absence of the pit in the central track. This will be understood from the fact that sampled signals in the cases shown in sections (a) to (d) of FIG. 6B do not provide an effective amplitude in the sum of these signals.

Thus, if the track pitch is larger than that shown in FIG. 7A, i.e., if the track pitch is larger than the pitch resolution limit λ/(2×NA), either of the sampled signals in the case of the presence of the pit and the sampled signal in the case of the absence of the pit may be multiplied by a suitable coefficient and then inverted in the polarity thereof before addition of these sampled signals, for obtaining a better sensitivity.

In addition, if the sampled signals have less stability of the amplitude in either of the cases of the presence and the absence, the detection sensitivity for the sampled signals having less stability is lowered compared to the other sampled signals, for improving the stability of the final tracking error signal. The detection sensitivity may be selected by adjusting the coefficient for multiplication.

The method of the present embodiment also reduces the off-set of the signals caused by asymmetry of the shape of the optical spot.

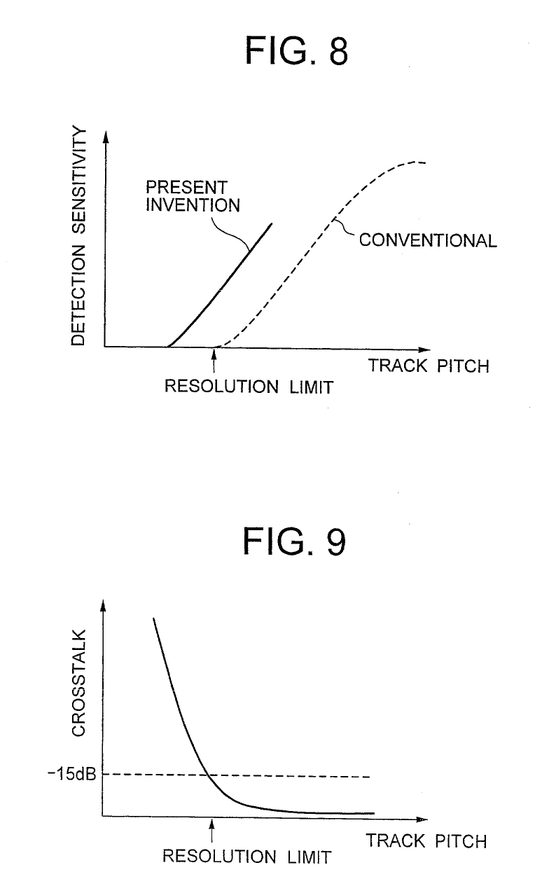

In FIG. 6A, the space period of the pits 11 along the track i12 s selected at double the track pitch 13. This is selected in consideration of the fact that the critical track pitch providing an effective tracking error signal in the present embodiment is half the pitch resolution limit λ/(2×NA). This is shown by a solid line depicted in FIG. 8 in comparison with a dotted line, which corresponds to the conventional method.

The judgement of the presence or absence of the pit in the central track is achieved by judging whether or not the reflected light exceeds a suitable threshold determined beforehand. However, a further smaller track pitch prevents an accurate judgement due to the increase of the crosstalk from adjacent tracks. The crosstalk is defined by a level ratio of the fluctuation of the reproduced signal due to the influence by the adjacent tracks to the level of the reproduced signal at the current track. The crosstalk increases abruptly to degrade the signal quality if the track pitch falls below the pitch resolution limit, as shown in FIG. 9.

In a practical disk drive, the judgement of the presence or absence of the pit can be achieved, if the crosstalk is below −15 dB, as shown in FIG. 9. Thus, the vicinity of the pitch resolution limit substantially determines the allowable track pitch in a typical disk drive. However, the method of the present embodiment allows the track pitch, which is smaller than the pitch resolution limit, to provide a sufficient sensitivity for the tracking error signal, as will be understood from FIGS. 3A to 3C.

[Second Embodiment]

The second embodiment is such that the present invention is applied to a 3-beam scheme wherein the tracking error signal is detected by taking advantage of the change of the amount of the reflected light due to the deviation of the optical spot with respect to the track center, as detailed hereinafter.

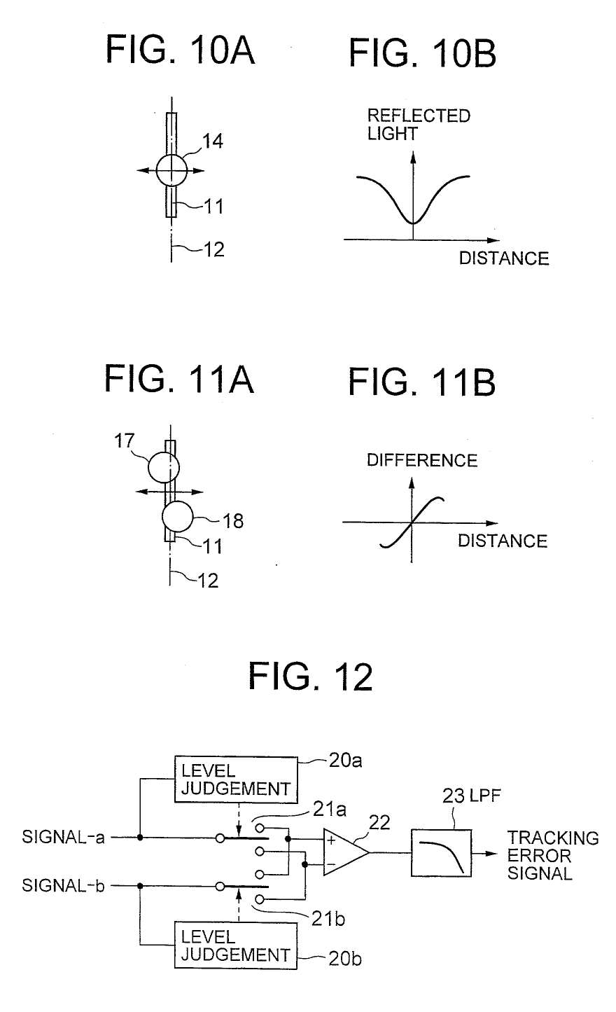

FIGS. 10A, 10B, 11A and 11B in combination show the principle of the 3-beam scheme. FIG. 10A depicts the locational relationship between a single spot 14 and the tracks 12, and FIG. 10B illustrates the far-field distribution of the reflected light in FIG. 10A. FIG. 11A depicts the locational relationship between a pair of optical spots 14 and the track 12, and FIG. 11B shows the difference between the amounts of reflected lights for the optical spots 17 and 18 shown in FIG. 11A. The pit formed on the track has a locational phase or reflectivity, which is different from that of the other area.

When the optical spot 14 residing at the track center as shown moves and deviates from the track center in FIG. 10A, the reflected light changes along the graph shown in FIG. 10B having an even function property, which is not suitable for generating the tracking error signal. On the other hand, if a pair of optical spots move and deviates in unison from the track center, as shown in FIG. 11A, the difference between the amounts of reflected lights changes along the graph shown in FIG. 11B having an odd function property. Thus, the difference signal may be used for generating the tracking error signal.

In the examples shown in FIGS. 10A and 11A are such that the reflectivity of the pit 11 is lower than the other area. If the pit has a higher reflectivity than the other area, the graph shown in FIG. 10B changes to a graph which is convex toward the top and the graph shown in FIG. 11b changes to a graph having an inverted amplitude. Since the pair of optical spots are generally provided sandwiching therebetween another optical spot used in reproduction of recorded data, this scheme is called a 3-beam scheme as recited before. Another scheme using a similar principle is also known, wherein a single optical spot is used and subjected to wobbling oscillation to detect the difference signal, the wobbling oscillation being performed with respect to the track center or along the track center. This scheme is also called herein a 3-beam scheme.

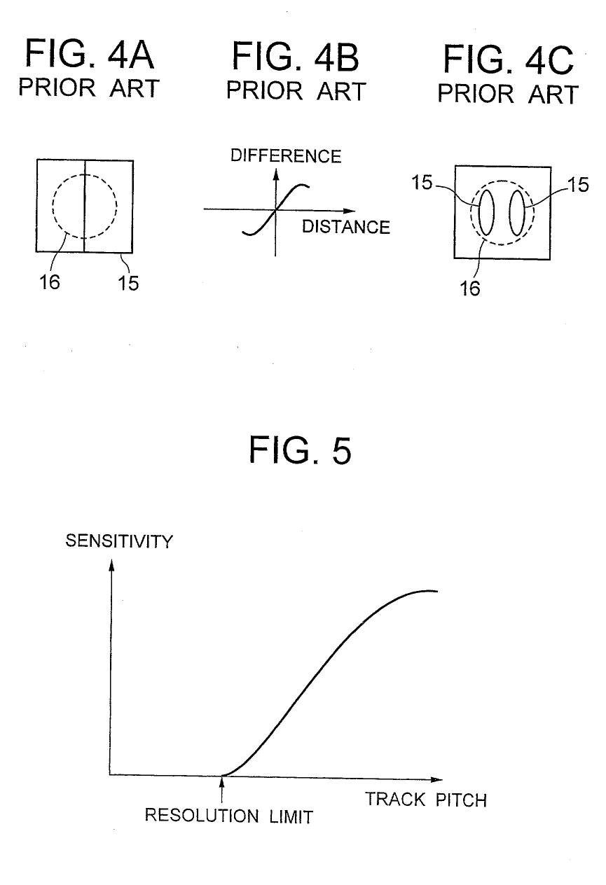

The signal characteristics of the tracking error signal generated in the 3-beam scheme are similar to those shown in FIGS. 6B and 7B, as will be understood from the resemblance between the graphs in FIG. 4B and FIG. 11B. Thus, as in the case of the first embodiment, the final tracking error signal can be obtained in the second embodiment, by the steps of multiplying either of groups of the sampled signals obtained in the cases of the presence and absence of the pit by a suitable coefficient, inverting the multiplied group of the sampled signals, for example, and then adding together both the groups for synthesis to obtain an effective tracking error signal. Thus, the second embodiment also achieves suitable sensitivity for generating the tracking error signal, such as shown in FIG. 8.

The 3-beam scheme is different from the push-pull scheme in that the pair of optical spots 17 and 18 shown in FIG. 11A are disposed apart from each other along the direction of the track. This necessitates separate judgements for the respective optical spots 17 and 18 to determine which group the sampled signals belong to.

FIG. 12 illustrates a circuit configuration of the drive circuit using the method of the present embodiment. The reflected lights obtained from the pair of optical spots are converted into electric signals, i.e., signal-a and signal-b, which are supplied to the level judgement sections 20a and 20b, respectively. The level judgement sections 20a and 20b respectively judge the levels of the reflected lights and judge as to the presence or absence of the pit on the current track.

If each of the level judgement sections 20a and 20b judges the presence of the pit in the vicinity of the corresponding optical spot, the each of the level judgment sections 20a and 20b controls a corresponding select switch 21a or 21b to select the non-inverting input of the differential amplifier 22. On the other hand, if the each of the level judgement sections 20a and 20b judges the absence of the pit, the each of the judgement sections 20a and 20b controls the corresponding select switch 21a or 21b to select the inverting input of the differential amplifier 22. The output of the differential amplifier 22 is fed through a low-pass-filter 23 and subjected to averaging therein with respect to time, thereby generating an effective tracking error signal.

It is to be noted that the level of the reflected light used for detecting the presence or absence of the pit is not a simple binary signal. This level may be changed based on the length of the pit in the direction of the track, and also affected by the presence or absence of the pits on the adjacent tracks.

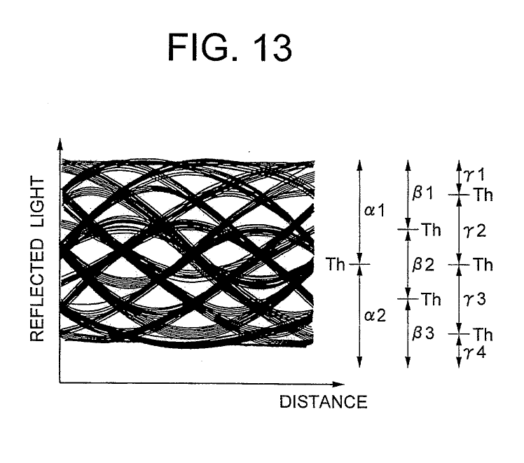

FIG. 13 shows an example of the eye pattern representing the change of the amount of reflected light from a high-density optical disk during a scanning operation of the optical spot. A most simple method for judgement of the presence or absence of the pit is such that a mean value or the vicinity thereof is used as a threshold for judging whether the reflected light is above the threshold (to reside in an area α1) or below the threshold (to reside in an area α2).

Whether the amount of the reflected light from the pit is higher or lower than that from the mirror surface depends on the structure of the optical disk. In view of this, when the amount of reflected light from the pit is lower than that from the mirror surface, the judgement section can judge the presence of the pit if the amount of the reflected light resides in the area α2 and judge the absence of the pit if the amount of the reflected light resides in the area α1.

It should be noted that the level judgement in the above process may involve an error for the levels in the vicinity of the boundary, or center of the amplitude. Thus, a pair of thresholds may be provided for the judgement to divide the levels into three areas β1, β2 and β3. In this case, the detected signal having a level residing in the area β2 is discarded, and only the detected signal having a level residing in the areas β1 and β3 are used for averaging to obtain an effective tracking error signal. This scheme improves the stability of the tracking error signal thus obtained.

In the example shown in FIGS. 6A and 6B representing a narrow pitch arrangement, assuming that the amounts of reflected lights in sections (a), (b), . . . (h) are represented by A, B, . . . H , the relationship between the amounts of reflected lights are as follows:

A>B=C>D>E>F=G>H (1)

On the other hand, in the example shown in FIGS. 7A and 7B representing a cut-off arrangement, assuming that similar representations are used, the relationship between the amounts of the reflected lights are as follows:

D=E>B=C=F=G>A=H=0 (2)

It will be understood that detection sensitivity assumes zero in the case of section (a) in FIG. 6A wherein the amount of reflected light assumes a maximum and in the case of section (h) in FIG. 7A wherein the amount of reflected light assumes a minimum.

Thus, another scheme may be employed using three (or more) thresholds to divide the level of the reflected light into further more areas, as shown by four areas γ1 to γ4 in FIG. 13. In this case, the detected signal having a level residing in the areas γ1 and γ4 are discarded for obtaining the effective tracking error signal.

The judgement of the presence or absence of the pit may use the results of reproduction of the recorded data instead of the level of the reflected light. In this case, a partial response maximum likelihood (PRML) technique, for example, can be used for correcting the error of the judgement of the levels, to thereby accurately judge the presence or absence of the pit. If such a technique for signal processing is used, a delay is involved in the judgement. However, the delay itself does not cause a serious problem partly because the detected signal may be subjected to sampling and A/D conversion thereof, and then stored in the memory for later signal processing by using a logic circuit, and partly because the final tracking error signal to be used for servo control is a low-frequency signal.

In the above embodiments, either of the groups of the sampled signals is multiplied by a suitable coefficient. However, both the groups of the sampled signals may be multiplied by suitable coefficients independently selected.

Since the above embodiments are described only for examples, the present invention is not limited to the above embodiments and various modifications or alterations can be easily made therefrom by those skilled in the art without departing from the scope of the present invention.

What is claimed is:

1. A method for generating a tracking error signal comprising the steps of:
irradiating an optical spot onto a current track of an optical disk;
generating a first signal representing an amount of reflected light from said optical disk;
judging presence or absence of a pit irradiated by said optical spot on said current track; and
averaging said first signal with respect to time while inverting said first signal obtained during either the presence or the absence of the pit.

2. The method as defined in claim 1, wherein said averaging step comprises the step of multiplying said first signal obtained during either the presence or the absence of the pit by a coefficient.

3. The method as defined in claim 1, wherein said averaging step comprises the step of multiplying said first signal obtained during both of the presence and absence of the pit by different coefficients.

4. The method as defined in claim 1, wherein said judging step is performed by using said amount of reflected light.

5. The method as defined in claim 1, wherein said averaging step comprises the step of determining a level of said first signal among a plurality of levels.

6. The method as defined in claim 5, wherein said averaging step comprises the step of multiplying said first signal having a specified level by a coefficient.

7. The method as defined in claim 6, wherein said coefficient is zero for a specified level or levels among said plurality of levels.

8. The method as defined in claim 1, wherein said optical disk has a cut-off arrangement of track pitch.

9. The method as defined in claim 1, wherein said irradiating step irradiates a pair of optical spots.

10. The method as defined in claim 1, wherein said generating step uses a push-pull scheme.

11. A tracking error signal generating system comprising:
an optical unit for irradiating an optical spot onto a current track of an optical disk;
a photosensor unit for generating a first signal representing an amount of reflected light from said optical disk;
a judgement section for judging presence or absence of a pit irradiated by said optical spot on said current track; and
a signal processing section for averaging said first signal with respect to time while inverting said first signal obtained during either the presence or the absence of the pit to generate a tracking error signal.

12. The system as defined in claim 11, wherein said signal processing section comprises a multiplying unit for multiplying said first signal obtained during either the presence or the absence of the pit by a coefficient.

13. The system as defined in claim 11, wherein said signal processing section comprises a multiplying unit for multiplying said first signal obtained during both of the presence and absence of the pit by different coefficients.

14. The system as defined in claim 1, wherein said judgement section judges the presence or absence of the pit based on said amount of reflected light.

15. The system as defined in claim 11, wherein said signal processing section comprises a level judgment unit for determining a level of said first signal among a plurality of levels.

16. The system as defined in claim 15, wherein said signal processing section multiplies said first signal having a specified level by a coefficient.

17. The system as defined in claim 16, wherein said coefficient is zero for a specified level or levels among said plurality of levels.

18. The system as defined in claim 11, wherein said optical disk has a cut-off arrangement of track pitch.

19. The system as defined in claim 11, wherein said optical unit irradiates a pair of optical spots.

20. The system as defined in claim 11, wherein said photosensor unit uses a push-pull scheme.
